(19) United States
(12) Patent Application Publication
(10) Pub. No.: US 2016/0139714 A1
(43) Pub. Date: May 19, 2016

(54) Transparent Display Device

(71) Applicant: SHENZHEN CHINA STAR OPTOELECTRONICS TECHNOLOGY CO., LTD., Guangdong (CN)

(72) Inventors: Yu-Chun HSIAO, Guangdong (CN); Shih Hsiang CHEN, Guangdong (CN); Guofu TANG, Guangdong (CN); Quan LI, Guangdong (CN); Chengling LV, Guangdong (CN); Chaofan GUO, Guangdong (CN)

(73) Assignee: SHENZHEN CHINA STAR OPTOELECTRONICS TECHNOLOGY CO., LTD., Guangdong (CN)

(21) Appl. No.: 14/409,858

(22) PCT Filed: Nov. 28, 2014
(86) PCT No.: PCT/CN2014/092523

§ 371 Date: Dec. 19, 2014

(30) Foreign Application Priority Data
Nov. 17, 2014 (CN) 201410658618.7

(51) Int. Cl. G06F 3/041; G09G 3/36; G09G 3/34

(52) U.S. Cl. CPC G06F 3/0412; G09G 3/348; G09G 3/36; G09G 3/3406; G09G 2310/0235; G09G 2300/023; G06F 2203/04804

(57) ABSTRACT

A transparent display device includes a first display panel system, a second display panel system, a first multi-mode panel, a light source, a front display panel, and a back display panel. The multiple display panel system and the multi-mode panel are adopted by the present transparent display device so the front and back display panels of the present transparent display device can show different images at the same time. Owing to the present transparent display device, the technical problem that the front and back display panels of the conventional transparent display device cannot show different images at the same time is successfully settled.

### BACKGROUND OF THE INVENTION

1. Field of the Invention

The present invention relates to the field of displays, and more particularly, to a transparent display device.

2. Description of the Prior Art

Please refer to FIG. 1 showing a schematic diagram of a conventional transparent display device 10. The transparent display device 10 comprises a front display panel 101, a back display panel 102, a light source 103, a multi-mode panel 104, and a display panel system 105. The display panel system 105 is used for displaying images. The images can be viewed on the front display panel 101 and the back display panel 102. The front display panel 101 can be seen from the opposite side of the transparent display device 10. The back display panel 102 can be seen from the opposite side of the transparent display device 10. The multi-mode panel 104 is used for allowing the images to be viewed on the front display panel 101 and the back display panel 102. In addition, the multi-mode panel 104 is used for blocking the images to be viewed on the front display panel 101 and the back display panel 102.

For users of the transparent display device 10, they can view images shown on both of the front display panel and the back display panel. But more specifically, they can only view identical images shown on both of the front display panel and the back display panel at the same time rather than viewing different images shown on both of the front display panel and the back display panel at the same time.

Therefore, it is necessary to provide a new transparent display device for solving the problem occurring in the conventional technology.

### SUMMARY OF THE INVENTION

An object of the present invention is to provide a transparent display device comprising a front display panel and a back display panel capable of showing images different images shown on the front display panel for solving a technical problem in the conventional technology; that is, the front display panel of the conventional transparent display device cannot show images different from images shown on the back display panel.

According to the present invention, a transparent display device comprises a first display panel system for displaying a first image, a second display panel system for displaying a second image, a first multi-mode panel disposed between the first display panel system and the second display panel system, a light source disposed at a lateral side of the first display panel system and a lateral side of the second display panel system, for supplying light to the first display panel system and the second display panel system, a front display panel disposed on an outer side of the first display panel system, for showing images on the front of the transparent display device, and a back display panel disposed on an outer side of the second display panel system, for showing images on the back of the transparent display device. Both of the first display panel system and the second display panel system comprise at least one of a liquid crystal display (LCD) panel and an organic electric display panel, and the first multi-mode panel comprises an active reflector, an active diffuser, an active shutter, or an electrowetting panel.

In one aspect of the present invention, the light source is disposed on both lateral sides of the first display panel system and both lateral sides of the second display panel system.

In another aspect of the present invention, the light source is disposed on a single lateral side of the first display panel system and a single lateral side of the second display panel system.

In another aspect of the present invention, the transparent display device further comprises a first touch panel, disposed between the front display panel and the first display panel system.

In another aspect of the present invention, the transparent display device further comprises a second touch panel, disposed between the back display panel and the second display panel system.

In another aspect of the present invention, the transparent display device further comprises a second multi-mode panel, disposed between the second display panel system and the back display panel.

In another aspect of the present invention, the transparent display device further comprises a third multi-mode panel, disposed between the first display panel system and the front display panel.

In still another aspect of the present invention, the second multi-mode panel comprises an active reflector, an active diffuser, an active shutter, or an electrowetting panel.

In yet another aspect of the present invention, the third multi-mode panel comprises an active reflector, an active diffuser, an active shutter, or an electrowetting panel.

According to the present invention, a transparent display device comprises a first display panel system for displaying a first image, a second display panel system for displaying a second image, a first multi-mode panel disposed between the first display panel system and the second display panel system, a light source disposed at a lateral side of the first display panel system and a lateral side of the second display panel system, for supplying light to the first display panel system and the second display panel system, a front display panel disposed on an outer side of the first display panel system, for showing images on the front of the transparent display device, and a back display panel disposed on an outer side of the second display panel system, for showing images on the back of the transparent display device.

In one aspect of the present invention, the light source is disposed on both lateral sides of the first display panel system and both lateral sides of the second display panel system.

In another aspect of the present invention, the light source is disposed on a single lateral side of the first display panel system and a single lateral side of the second display panel system.

In another aspect of the present invention, the transparent display device further comprises a first touch panel, disposed between the front display panel and the first display panel system.

In another aspect of the present invention, the transparent display device further comprises a second touch panel, disposed between the back display panel and the second display panel system.

In another aspect of the present invention, the transparent display device further comprises a second multi-mode panel, disposed between the second display panel system and the back display panel.

In another aspect of the present invention, the transparent display device further comprises a third multi-mode panel, disposed between the first display panel system and the front display panel.

In another aspect of the present invention, both of the first display panel system and the second display panel system comprise at least one of a liquid crystal display (LCD) panel and an organic electric display panel.

In another aspect of the present invention, the first multi-mode panel comprises an active reflector, an active diffuser, an active shutter, or an electrowetting panel.

In still another aspect of the present invention, the second multi-mode panel comprises an active reflector, an active diffuser, an active shutter, or an electrowetting panel.

In yet another aspect of the present invention, the third multi-mode panel comprises an active reflector, an active diffuser, an active shutter, or an electrowetting panel.

Compared with the conventional transparent display device, a multiple display panel system and a multi-mode panel are used in the present transparent display device so the front and back display panels of the present transparent display device can show different images at the same time. Owing to the present transparent display device, the technical problem that the front and back display panels of the conventional transparent display device cannot show different images at the same time is successfully settled.

These and other features, aspects and advantages of the present disclosure will become understood with reference to the following description, appended claims and accompanying figures.

### BRIEF DESCRIPTION OF THE DRAWINGS

FIG. 1 shows a schematic diagram of a conventional transparent display device.

FIG. 2 is a schematic diagram showing the structure of a transparent display device according to a first preferred embodiment of the present invention.

FIG. 3 is a schematic diagram showing the structure of a transparent display device according to a second preferred embodiment of the present invention.

FIG. 4 is a schematic diagram showing the structure of a transparent display device according to a third preferred embodiment of the present invention.

FIG. 5 is a schematic diagram showing the structure of a transparent display device according to a fourth preferred embodiment of the present invention.

FIG. 6 is a schematic diagram showing the structure of a transparent display device according to a fifth preferred embodiment of the present invention.

FIG. 7 is a schematic diagram showing the structure of a transparent display device according to a sixth preferred embodiment of the present invention.

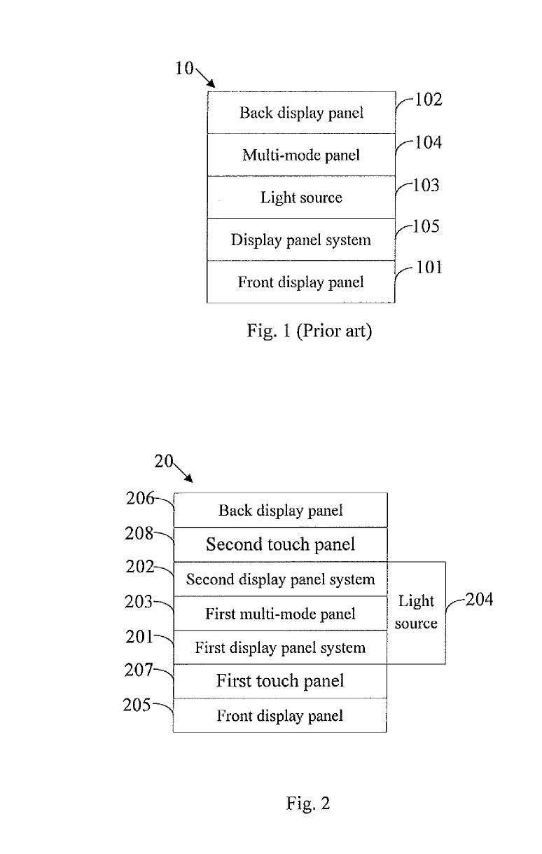

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It is noted that the same components are labeled by the same number.

Please refer to FIG. 2. FIG. 2 is a schematic diagram showing the structure of a transparent display device 20 according to a first preferred embodiment of the present invention. The transparent display device 20 comprises a first display panel system 201, a second display panel system 202, a first multi-mode panel 203, a light source 204, a front display panel 205, a back display panel 206, a first touch panel 207, and a second touch panel 208.

The first display panel system 201 is used for showing a first image. The second display panel system 202 is used for showing a second image. The first multi-mode panel 203 is disposed between an area of the first display panel system 201 and the second display panel system 202 for allowing or blocking the first image to be shown on the back display panel 206 and for allowing or blocking the second image to be shown on the front display panel 205. The light source 204 is disposed at a lateral side of the first display panel system 201 and a lateral side of the second display panel system 202 for supplying the first image shown on the first display panel system 201 and the second image shown on the second display panel system 202 with a display light source. The light source 204 is disposed on a single side of the first display panel system 201 and the second display panel system 202. The front display panel 205 is disposed on an outer side of the first display panel system 201 for showing the images on the front of the transparent display device 20. The back display panel 206 is disposed on an outer side of the second display panel system 202 for showing the images on the back of the transparent display device 20. The first touch panel 207 is disposed between the front display panel 205 and the first display panel system 201 for receiving a touch signal from the front display panel 205. The second touch panel 208 is disposed between the back display panel 206 and the second display panel system 202 for receiving a touch signal from the back display panel 206.

A liquid crystal display (LCD) panel, an organic electric display panel, and the combination of the above-mentioned panels may be used as the first display panel system 201 and the second display panel system 202 for showing a better first image and a better second image.

The first multi-mode panel 203 comprises an active reflector, an active diffuser, an active shutter, an electrowetting panel, or a combination of the above-mentioned devices for turning on or turning off the panel more easily. In this way, the first image is allowed or blocked to be shown on the back display panel 206. Also, the second image is allowed or blocked to be shown on the front display panel 205.

While the active reflector, the active diffuser, the active shutter, or the electrowetting panel is turned on, the first image is blocked to be shown on the back display panel 206 and the second image is blocked to be shown on the front display panel 205. While the active reflector, the active diffuser, the active shutter, or the electrowetting panel is turned off, the first image is allowed to be shown on the back display panel 206 and the second image is allowed to be shown on the front display panel 205.

It is possible that both of the first touch panel 207 and the second touch panel 208 are disposed or either the first touch panel 207 or the second touch panel 208 is disposed. It depends on users' request.

The transparent display device 20 operates, and the front display panel 205 and the back display panel 206 start to show an identical image. While the first multi-mode panel 203 is turned on, the identical image is shown through the first display panel system 201, the second display panel system 202, or through both of the first display panel system 201 and the second display panel system 202. That's why the identical image is shown on both of the front display panel 205 and the back display panel 206. The identical image can be shown partially through the first display panel system 201 and the second display panel system 202, respectively. Afterwards, the partial images become a complete image on the front display panel 205 and the back display panel 206 for increasing the resolution of the image.

Provided that different images are shown on the front display panel 205 and the back display panel 206, the first image of the 201 is shown on the front display panel 205, and the second image of the back display panel 206 is shown on the second display panel system 202 once the first multi-mode panel 203 is turned off. Since the image shown on the front display panel 205 is different from the image shown on the back display panel 206, so no interference occurs.

When the front display panel 205 and the back display panel 206 show images independently, the first multi-mode panel 203 is turned on or turned off as users' wish. For example, the first multi-mode panel 203 is turned off when the user wants to view images shown on the front display panel 205 only or on the back display panel 206 only.

Since the multiple display panel system and the multi-mode panel are adopted by the transparent display device provided by the preferred embodiment, the front and back display panels of the present transparent display device can show different images.

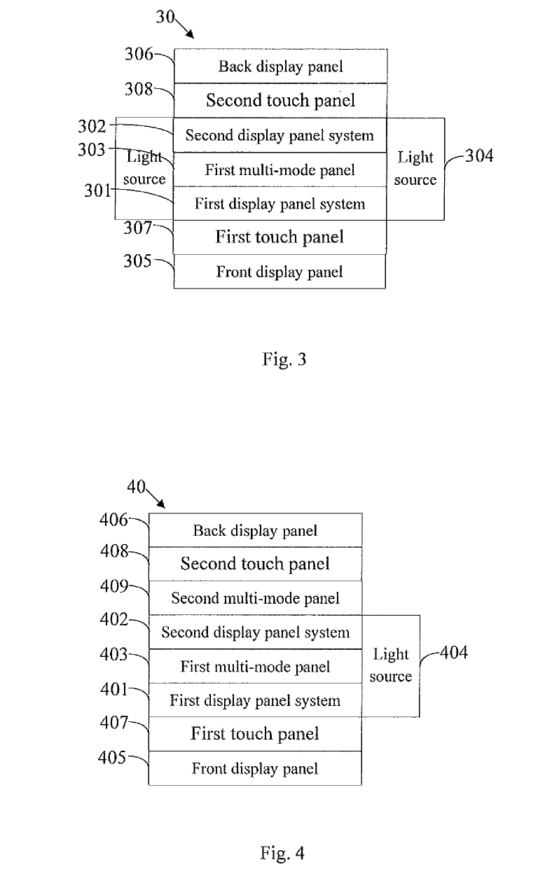

FIG. 3 is a schematic diagram showing the structure of a transparent display device 30 according to a second preferred embodiment of the present invention. The transparent display device 30 comprises a first display panel system 301, a second display panel system 302, a first multi-mode panel 303, two light sources 304, a front display panel 305, a back display panel 306, a first touch panel 307, and a second touch panel 308.

Differing from the transparent display device 20, the light sources 304 of the transparent display device 30 is disposed on both lateral sides of the first display panel system 301 and both lateral sides of the second display panel system 302 for further enhancing the display effect of the transparent display device 30. It is possible that each of the light sources 304 supplies the first display panel system 301 and the second display panel system 302 with a display light source independently. It is also possible that both of the light sources 304 supply the first display panel system 301 and the second display panel system 302 with a display light source at the same time.

Based on the transparent display device 20 provided by the first embodiment, the transparent display device 30 provided by this preferred embodiment comprises the light sources 304 disposed at the both lateral sides for further increasing the display effect of the transparent display device 30.

FIG. 4 is a schematic diagram showing the structure of a transparent display device 40 according to a third preferred embodiment of the present invention. The transparent display device 40 comprises a first display panel system 401, a second display panel system 402, a first multi-mode panel 403, a light source 404, a front display panel 405, a back display panel 406, a first touch panel 407, a second touch panel 408, and a second multi-mode panel 409.

Based on the transparent display device 20 provided by the first embodiment, the transparent display device 40 provided by this preferred embodiment further comprises the second multi-mode panel 409. The second multi-mode panel 409 is disposed between the second display panel system 402 and the back display panel 406. The second multi-mode panel 409 is used for allowing or blocking the first image and the second image to be shown on the back display panel 406.

The first display panel system 401 and the second display panel system 402 may be an LCD panel, an organic electric display panel, or a combination of the above-mentioned panels for showing the first image and the second image better.

The second multi-mode panel 409 comprises an active reflector, an active diffuser, an active shutter, an electrowetting panel, or a combination of the above-mentioned devices for turning on or turning off the panel more easily. In this way, the first image and the second image are allowed or blocked to be shown on the back display panel 406.

While the active reflector, the active diffuser, the active shutter, or the electrowetting panel is turned on, the first image and the second image are blocked to be shown on the back display panel 406. While the active reflector, the active diffuser, the active shutter, or the electrowetting panel is turned off, the first image and the second image are allowed to be shown on the back display panel 406.

The first touch panel 407 and the second touch panel 408 are disposed completely or partially according to users' requirements.

The transparent display device 40 operates, and the first display panel system 401 and the second display panel system 402 start to show an identical image. The image is allowed or blocked to be shown on the back display panel 406 when the second multi-mode panel 409 is turned on or turned off. In this way, any image with a high resolution will not be viewed by other people on the back display panel 406.

As for the realization of the transparent display device 40 in other situations, it can refer to the transparent display device 20 in the first embodiment since the methods for realizing the two transparent display devices are the same or very similar. The details can be refer to the description in the first preferably embodiment.

Based on the transparent display device 20 provided by the first embodiment, the transparent display device 40 provided by the preferred embodiment comprises a second multi-mode panel for enhancing the ability of secret display of a high resolution frame of the transparent display device 40.

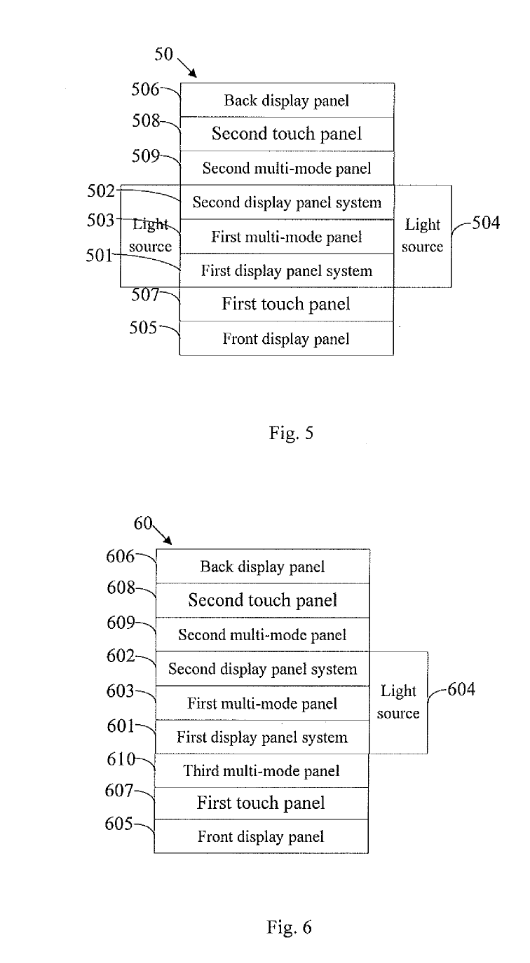

FIG. 5 is a schematic diagram showing the structure of a transparent display device 50 according to a fourth preferred embodiment of the present invention. The transparent display device 50 comprises a first display panel system 501, a second display panel system 502, a first multi-mode panel 503, two light sources 504, a front display panel 505, a back display panel 506, a first touch panel 507, a second touch panel 508, and a second multi-mode panel 509.

Differing from the transparent display device 40, the light sources 504 of the transparent display device 50 are disposed on both lateral sides of the first display panel system 501 and both lateral sides of the second display panel system 502 for further enhancing the display effect of the transparent display device 50. It is possible that each of the light sources 504 supplies the first display panel system 501 and the second display panel system 502 with a display light source independently. It is also possible that both of the light sources 504 supply the first display panel system 501 and the second display panel system 502 with a display light source at the same time.

Based on the transparent display device 40 provided by the third embodiment, the transparent display device 50 provided by this preferred embodiment comprises the light sources 504 disposed at the both lateral sides for further increasing the display effect of the transparent display device 50.

FIG. 6 is a schematic diagram showing the structure of a transparent display device 60 according to a fifth preferred embodiment of the present invention, The transparent display device 60 comprises a first display panel system 601, a second display panel system 602, a first multi-mode panel 603, a light source 604, a front display panel 605, a back display panel 606, a first touch panel 607, a second touch panel 608, a second multi-mode panel 609, and a third multi-mode panel 610.

Based on the transparent display device 40 provided by the third embodiment, the transparent display device provided by the preferred embodiment comprises the third multi-mode panel 610. The third multi-mode panel 610 is disposed between an area of the first display panel system 601 and the front display panel 605 for allowing or blocking the first image and the second image to be shown on the front display panel 605.

The first display panel system 601 and the second display panel system 602 may be an LCD panel, an organic electric display panel, or a combination of the above-mentioned panels for showing the first image and the second image better.

The third multi-mode panel 610 comprises an active reflector, an active diffuser, an active shutter, an electrowetting panel, or a combination of the above-mentioned devices for turning on or turning off the panel more easily. In this way, the first image and the second image are allowed or blocked to be shown on the front display panel 605.

While the active reflector, the active diffuser, the active shutter, or the electrowetting panel is turned on, the first image and the second image are blocked to be shown on the front display panel 605. While the active reflector, the active diffuser, the active shutter, or the electrowetting panel is turned off, the first image and the second image are allowed to be shown on the front display panel 605.

The first touch panel 607 and the second touch panel 608 are disposed completely or partially as users' request.

The transparent display device 60 operates, and the first display panel system 601 and the second display panel system 602 start to show an identical image. The image is allowed or blocked to be shown on the front display panel 605 when the third multi-mode panel 610 is turned on or turned off. In this way, any image with a high resolution will not be viewed by other people on the front display panel 605.

As for the realization of the transparent display device 60 in other situations, it can refer to the transparent display device 40 in the third embodiment since the methods for realizing the two transparent display devices are the same or very similar. The details can be refer to the description in the third preferably embodiment.

Based on the transparent display device 40 provided by the third embodiment, the transparent display device 60 provided by this preferred embodiment further comprises the third multi-mode panel for enhancing the ability of secret display of a high resolution frame of the transparent display device.

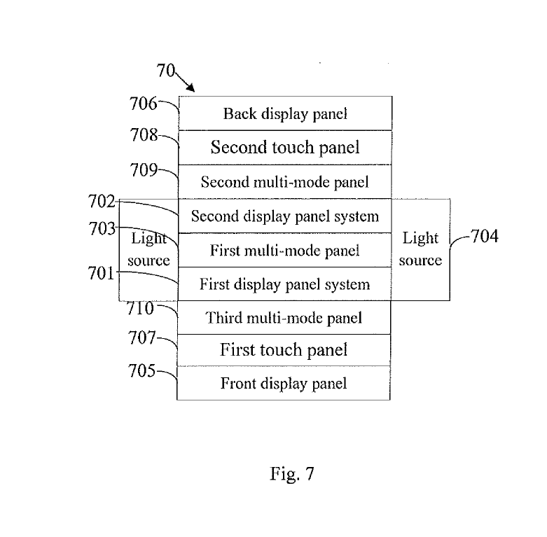

FIG. 7 is a schematic diagram showing the structure of a transparent display device 70 according to a sixth preferred embodiment of the present invention. The transparent display device 70 comprises a first display panel system 701, a second display panel system 702, a first multi-mode panel 703, two light sources 704, a front display panel 705, a back display panel 706, a first touch panel 707, a second touch panel 708, a second multi-mode panel 709, and a third multi-mode panel 710.

Differing from the transparent display device 60 in the fifth preferred embodiment, the light sources 704 of the transparent display device 70 is disposed on both lateral sides of the first display panel system 701 and both lateral sides of the second display panel system 702 for further enhancing the display effect of the transparent display device 70. It is possible that each of the light sources 704 supplies the first display panel system 701 and the second display panel system 702 with a display light source independently. It is also possible that both of the light sources 704 supply the first display panel system 701 and the second display panel system 702 with a display light source at the same time.

Based on the transparent display device 60 provided by the fifth preferred embodiment, the transparent display device 70 provided by this preferred embodiment comprises the light sources 704 disposed at the both lateral sides for improving the display effect of the transparent display device 70.

The multiple display panel system and the multi-mode panel are adopted by the present transparent display device so the front and back display panels of the present transparent display device can show different images at the same time. Owing to the present transparent display device, the technical problem that the front and back display panels of the conventional transparent display device cannot show different images at the same time is successfully settled.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A transparent display device, comprising:
a first display panel system, for displaying a first image;
a second display panel system, for displaying a second image;
a first multi-mode panel, disposed between the first display panel system and the second display panel system;
a light source, disposed at a lateral side of the first display panel system and a lateral side of the second display panel system, for supplying light to the first display panel system and the second display panel system;
a front display panel, disposed on an outer side of the first display panel system, for showing images on the front of the transparent display device; and
a back display panel, disposed on an outer side of the second display panel system, for showing images on the back of the transparent display device;
wherein both of the first display panel system and the second display panel system comprise at least one of a liquid crystal display (LCD) panel and an organic electric display panel, and the first multi-mode panel comprises an active reflector, an active diffuser, an active shutter, or an electrowetting panel.

2. The transparent display device as claimed in claim 1, wherein the light source is disposed on both lateral sides of the first display panel system and both lateral sides of the second display panel system.

3. The transparent display device as claimed in claim 1, wherein the light source is disposed on a single lateral side of the first display panel system and a single lateral side of the second display panel system.

4. The transparent display device as claimed in claim 1, further comprising:
a first touch panel, disposed between the front display panel and the first display panel system.

5. The transparent display device as claimed in claim 1, further comprising:
a second touch panel, disposed between the back display panel and the second display panel system.

6. The transparent display device as claimed in claim 1, further comprising:
a second multi-mode panel, disposed between the second display panel system and the back display panel.

7. The transparent display device as claimed in claim 6, further comprising:
a third multi-mode panel, disposed between the first display panel system and the front display panel.

8. The transparent display device as claimed in claim 6, wherein the second multi-mode panel comprises an active reflector, an active diffuser, an active shutter, or an electrowetting panel.

9. The transparent display device as claimed in claim 7, wherein the third multi-mode panel comprises an active reflector, an active diffuser, an active shutter, or an electrowetting panel.

10. A transparent display device, comprising:
a first display panel system, for displaying a first image;
a second display panel system, for displaying a second image;
a first multi-mode panel, disposed between the first display panel system and the second display panel system;
a light source, disposed at a lateral side of the first display panel system and a lateral side of the second display panel system, for supplying light to the first display panel system and the second display panel system;
a front display panel, disposed on an outer side of the first display panel system, for showing images on the front of the transparent display device; and
a back display panel, disposed on an outer side of the second display panel system, for showing images on the back of the transparent display device.

11. The transparent display device as claimed in claim 10, wherein the light source is disposed on both lateral sides of the first display panel system and both lateral sides of the second display panel system.

12. The transparent display device as claimed in claim 10, wherein the light source is disposed on a single lateral side of the first display panel system and a single lateral side of the second display panel system.

13. The transparent display device as claimed in claim 10, further comprising:
a first touch panel, disposed between the front display panel and the first display panel system.

14. The transparent display device as claimed in claim 10, further comprising:
a second touch panel, disposed between the back display panel and the second display panel system.

15. The transparent display device as claimed in claim 10, further comprising:
a second multi-mode panel, disposed between the second display panel system and the back display panel.

16. The transparent display device as claimed in claim 15, further comprising:
a third multi-mode panel, disposed between the first display panel system and the front display panel.

17. The transparent display device as claimed in claim 10, wherein both of the first display panel system and the second display panel system comprise at least one of a liquid crystal display (LCD) panel and an organic electric display panel.

18. The transparent display device as claimed in claim 10, wherein the first multi-mode panel comprises an active reflector, an active diffuser, an active shutter, or an electrowetting panel.

19. The transparent display device as claimed in claim 15, wherein the second multi-mode panel comprises an active reflector, an active diffuser, an active shutter, or an electrowetting panel.

20. The transparent display device as claimed in claim 16, wherein the third multi-mode panel comprises an active reflector, an active diffuser, an active shutter, or an electrowetting panel.
